(19) United States
(12) Patent Application Publication
(10) Pub. No.: US 2010/0165350 A1
(43) Pub. Date: Jul. 1, 2010

(54) Differential birefringent fiber frequency-modulated continuous-wave Sagnac gyroscope

(76) Inventor: Jesse Zheng, Vancouver (CA)

Correspondence Address: JESSE ZHENG, 6605 FLEMING STREET, VANCOUVER, BC, V5P3H3, CA

(21) Appl. No.: 12/159,592

(22) PCT Filed: Jan. 2, 2007
(86) PCT No.: PCT/CA2007/000003

§ 371 Date: Nov. 24, 2009

(30) Foreign Application Priority Data
Dec. 30, 2005 (CA) 2,531,177

(51) Int. Cl. G01C 19/72

(52) U.S. Cl. 356/465; 356/460

(57) ABSTRACT

Disclosed is a differential birefringent fiber frequency-modulated continuous-wave (FMCW) Sagnac gyroscope for measuring rotation velocity. The gyroscope uses a 90°-twisted single-mode birefringent fiber coil as a double unbalanced fiber-optic FMCW Sagnac interferometer, and uses the phase difference between the two beat signals from the fiber coil to determine the rotation velocity. This gyroscope can eliminate the nonreciprocal phase drift and provide a doubled resolution.

This invention relates to a differential birefringent fiber frequency-modulated continuous-wave (FMCW) Sagnac gyroscope used for measuring rotation velocity. Optical FMCW interference, a new technology derived from radar, can provide a higher accuracy and longer dynamic range than the classical homodyne interference, because optical FMCW interference naturally produces a dynamic signal and to calibrate the fractional phase, distinguish the phase shift direction and count the number of full periods is quite easy. The application of optical FMCW interference to rotation sensing not only can solve the problems in the conventional fiber-optic gyroscopes, such as zero-sensitivity point, inaccurate phase calibration, ambiguous shift direction determination and π-phase shift restriction, but also can reduce the size and weight of the gyroscopes because fiber-optic FMCW gyroscopes do not need bulk phase modulators or bulk frequency shifters.

The essential requirement for an optical FMCW Sagnac gyroscope is that the gyroscope should be unbalanced, so that the beat signal with a proper frequency can be obtained. This requirement, however, makes the gyroscope complicated in configuration and causes a nonreciprocal phase drift if the surrounding parameters (such as temperature) change.

The differential birefringent fiber FMCW Sagnac gyroscope exposed in this patent uses a 90°-twisted single-mode birefringent fiber coil as a double unbalanced fiber-optic FMCW Sagnac interferometer and uses the phase difference between the two beat signals from the fiber coil to determine the rotation velocity. Because the two beat signals have the same nonreciprocal phase drift and an opposite Sagnac phase shift, this gyroscope can remove the nonreciprocal phase drift (including the frequency drift of the laser) and provide a doubled resolution.

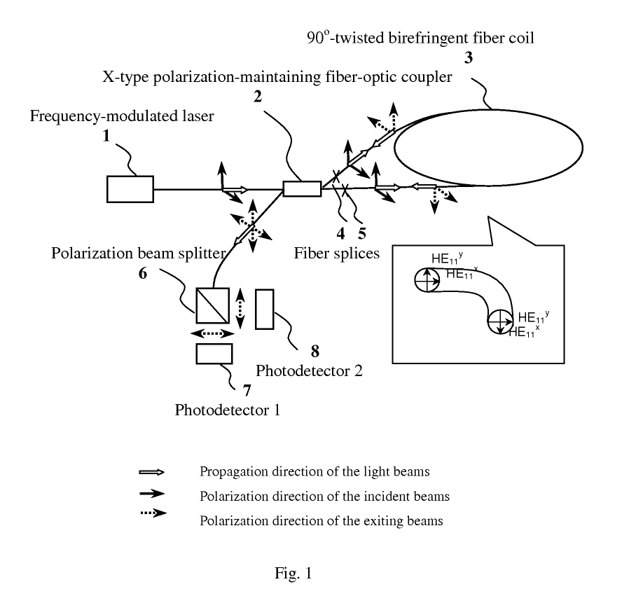

The differential birefringent fiber FMCW Sagnac gyroscope consists of a frequency-modulated laser 1, a X-type polarization-maintaining fiber-optic coupler 2, a single-mode birefringent fiber coil 3, two fiber splices 4, 5, a polarization beam splitter 6 and two photodetectors 7, 8. The output fibers of the fiber-optic coupler 2 are connected with the birefringent fiber coil 3 in the same polarization directions, and the coordinates of the principal axes on the two ends of the birefringent fiber coil 3 have a 90° (or n×180+90°, where n is an integer) rotation, as shown in FIG. 1.

A FMCW laser beam is first coupled into one input fiber of the fiber-optic coupler 2 in both polarization modes (i.e., the HE₁₁^{x} mode and the HE₁₁^{y} mode), and divided into four beams propagating along the two output fibers. These four beams are then coupled into the birefringent fiber coil 3 in two polarization modes from the two ends. Since the principle axes on the two ends of the birefringent fiber coil 3 have a 90° rotation, the clockwise-propagating HE₁₁^{x} mode beam and the anticlockwise-propagating HE₁₁^{y} mode beam will vibrate in the same direction after exiting the birefringent fiber coil and produce the first beat signal, while the clockwise-propagating HE₁₁^{y} mode beam and the anticlockwise-propagating HE₁₁^{x} mode beam will vibrate in another orthogonal direction after exiting the fiber coil and produce the second beat signal. These two optical beat signals are naturally perpendicular to each other, so that they can be separated by the polarization beam splitter 6. The separated two beat signals are detected by the two photodetectors 7, 8.

When the birefringent fiber coil rotates around its vertical axis, the two beat signals have an opposite phase shift due to the Sagnac effect. Therefore, comparing the phase difference between these beat signals, the rotational velocity of the gyroscope can be determined. For instance, if the frequency of the laser is modulated with a sawtooth waveform, the intensities of the detected beat signals I(t) in a modulation period can be written as

$$I ( t ) = {I}_{0} [ 1 + V cos ( \frac{2 π Δ {vv}_{m} OPD}{c} t + \frac{2 π}{{λ}_{0}} OPD \pm \frac{4 π RL Ω}{c {λ}_{0}} ) ] ,$$

where I₀ is the average intensity, V is the contrast, [symbol] v is the optical frequency modulation excursion, vₘ is the modulation frequency, λ₀ is the central optical wavelength in free space, and OPD is the absolute value of the initial optical path difference between the two interfering beams in each beat signal. The contrast V is given by

$$V = \frac{2 \sqrt{{I}_{1} {I}_{2}}}{{I}_{1} + {I}_{2}} \vert Sin c ( \frac{π}{{l}_{c}} OPD ) \vert ,$$

where I₁ and I₂ are the intensities of the two interfering beams in each beat signal, l_{c} is the coherence length of the laser. The OPD is given by

OPD=|nₑₓ−n_{ey}|L,

where nₑₓ and n_{ey} are the effective refractive indexes of the HE₁₁^{x} mode and the HE₁₁^{y} mode respectively, and L is the total length of the birefringent fiber coil. Obviously, the phase difference of the two beat signals [symbol] φ equals

$$Δφ = \frac{8 π RL Ω}{c {λ}_{0}} .$$

Hence, the rotation angular velocity of the birefringent fiber coil can be determined by

$$Ω = \frac{c {λ}_{0}}{8 π RL} Δφ .$$

Comparing with the conventional fiber-optic Sagnac gyroscopes, it can be seen that the differential birefringent fiber FMCW Sagnac gyroscope has a doubled sensitivity. Moreover, because AO is not relative to OPD, this gyroscope is free from the length variation of the fiber coil due to temperature or strain.

The advantages of this gyroscope include the following: (1) Benefiting from optical FMCW interference, the gyroscope has no problems of zero-sensitivity point, inaccurate phase calibration, ambiguous shift direction determination and π-phase shift restriction. Therefore, it can offer a higher resolution and a much longer dynamic range. (2) Profiting by the differential interferometer structure, the unexpected nonreciprocal phase drift in the gyroscope, even the frequency drift of the light source, can be automatically eliminated. In addition, the resolution of the gyroscope has been doubled. (3) Because of the all-fiber and fully passive structure, this gyroscope is very stable and compact.

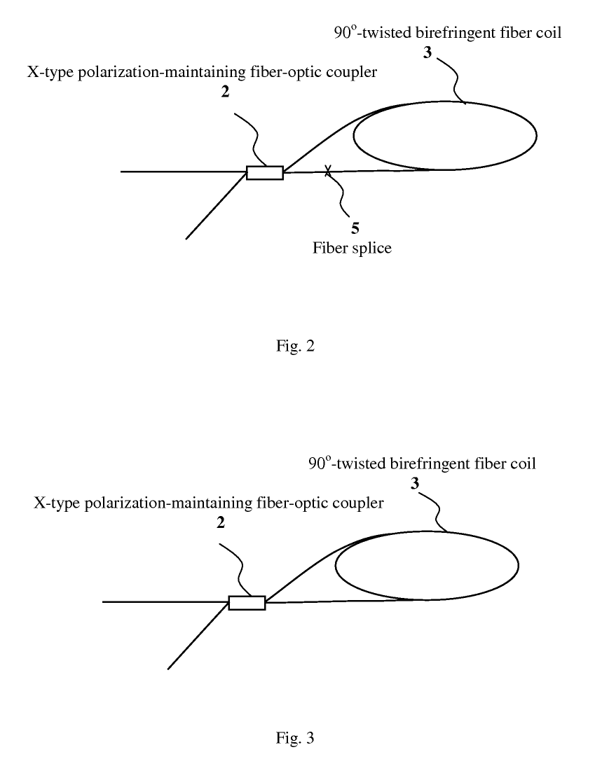

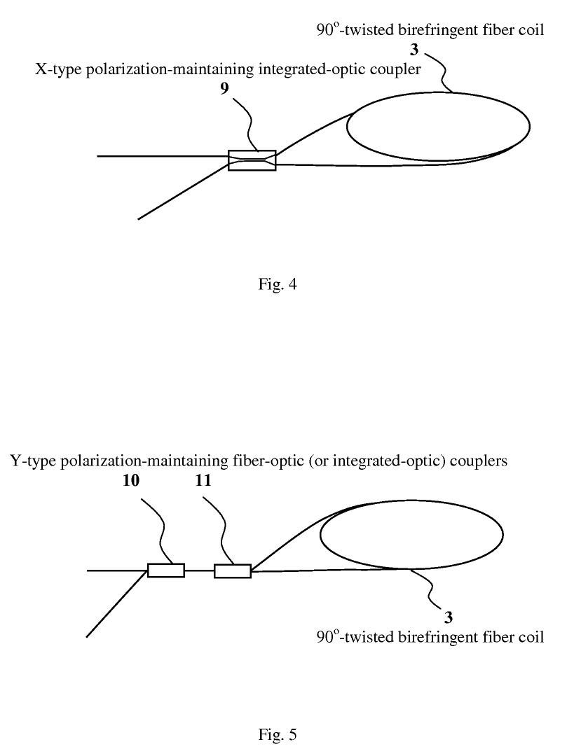

In this gyroscope, the 90°-twisted birefringent fiber coil 3 can be a portion of one output fiber of the X-type polarization-maintaining fiber-optic coupler 2 as shown in FIG. 2; or the X-type polarization-maintaining fiber-optic coupler 2 and the 90°-twisted birefringent fiber coil 3 can be made with a single length of birefringent fiber as shown in FIG. 3; or the X-type polarization-maintaining fiber-optic coupler 2 can be replaced by an X-type integrated-optic coupler 9 as shown in FIG. 4; or the X-type polarization-maintaining fiber-optic coupler can be replaced by two Y-type polarization-maintaining fiber-optic or by two Y-type integrated-optic couplers 10, 11, as shown in FIG. 5.

1. A differential birefringent fiber FMCW Sagnac gyroscope for measuring rotation velocity, comprising a frequency-modulated laser, a X-type 50/50 polarization-maintaining fiber-optic coupler, a single-mode birefringent fiber coil, two fiber splices, a polarization beam splitter, two photodetectors; wherein the output fibers of said fiber-optic coupler are connected with said birefringent fiber coil in the same polarization directions, and the coordinates of the principal axes on the two ends of said birefringent fiber coil have a 90° (or n×180+90°, where n is an integer) rotation;

2. A gyroscope as defined in claim 1, wherein the FMCW laser beam from said frequency-modulated laser is coupled equally into one input fiber of said fiber-optic coupler in both the HE₁₁^{x} mode and the HE₁₁^{y} mode, the four polarized beams from said coupler are coupled into said birefringent fiber coil in two polarization modes from the two ends, the optical beat signal produced by the clockwise-propagating HE₁₁^{x} mode beam and the anticlockwise-propagating HE₁₁^{y} mode beam and the optical beat signal produced by the clockwise-propagating HE₁₁^{y} mode beam and the anticlockwise-propagating HE₁₁^{x} mode beam are separated by said polarization beam splitter and detected by said two photodetectors, and the phase difference of these two beat signals is measured to determine the rotation velocity;

3. A gyroscope as defined in claim 1 or claim 2, wherein the output fibers of said fiber-optic coupler are connected with said birefringent fiber coil in the same polarization directions, and the coordinates of the principal axes on the two ends of said birefringent fiber coil have a 90° (or n×180+90°, where n is an integer) rotation;

4. A gyroscope as defined in claim 1 or claim 2 or claim 3, wherein said 90°-twisted birefringent fiber coil can be a portion of one output fiber of said X-type polarization-maintaining fiber-optic coupler;

5. A gyroscope as defined in claim 1 or claim 2 or claim 3, wherein said 90°-twisted birefringent fiber coil and said polarization-maintaining fiber-optic coupler can be made with a single length of single-mode birefringent fiber;

6. A gyroscope as defined in claim 1 or claim 2 or claim 3, wherein said X-type fiber-optic coupler can be an X-type integrated-optic coupler;

7. A gyroscope as defined in claim 1 or claim 2 or claim 3, wherein said X-type coupler can be made up of two Y-type polarization-maintaining fiber-optic couplers or two Y-type polarization-maintaining integrated-optic couplers;

8. A gyroscope as defined in claim 1 or claim 2, wherein the Sagnac phase shift and the rotation velocity are determined by comparing the phase difference between said two beat signals;

9. A method using for measuring rotation velocity, wherein a frequency-modulated laser beam is coupled equally into an 90° (or n×180+90°, where n is an integer)-twisted birefringent fiber coil in two polarization modes from the two ends, the beat signal produced by the clockwise-propagating HE₁₁^{x} mode beam and the anticlockwise-propagating HE₁₁^{y} mode beam and the orthogonal beat signal produced by the clockwise-propagating HE₁₁^{y} mode beam and the anticlockwise-propagating HE₁₁^{x} mode beam are separated and detected to determine the rotation velocity by comparing the phase difference.
